(19) United States
(12) Patent Application Publication
(10) Pub. No.: US 2019/0080302 A1
(43) Pub. Date: Mar. 14, 2019

(54) PAYMENT SYSTEM FOR FACILITATING DELIVERY TRANSACTIONS

(71) Applicant: MasterCard International Incorporated, Purchases, NY (US)

(72) Inventors: Yen Tran, Darien, CT (US); Shanthan Subramaniam, Baldwin Place, NY (US)

(21) Appl. No.: 15/699,375

(22) Filed: Sep. 8, 2017

(51) Int. Cl. G06Q 20/10; G06Q 20/26; G06Q 30/00

(52) U.S. Cl. CPC G06Q 20/10; G06Q 30/016; G06Q 20/26

(57) ABSTRACT

A request for payment is received from a payment recipient. The request includes (a) invoice details and a transaction amount for a transaction between the payment recipient and a buyer; (b) identification of the payment recipient; and (c) an identifier that identifies the buyer. Payment recipient account information and buyer account information is appended to the request for payment. The payment recipient account information identifies the payment recipient's bank and bank account. The buyer account information identifies the buyer's bank and bank account. The request for payment is transmitted, including at least a portion of the payment recipient and buyer account information. A confirmation is received that the request for payment has been executed.

### BACKGROUND

Cash-on-delivery (“COD”) transactions may present inconveniences or challenges for both the supplier and buyer. For example, in the context of a delivery by a supplier to a buyer's place of business, both parties may be reluctant to have employees handle cash, for reasons of safety and also from the point of view of financial loss control. Moreover, the buyer faces potential inconvenience in obtaining cash from the buyer's bank, while the supplier may find it inconvenient to make cash deposits to the supplier's bank.

Payment by check in a COD transaction also presents disadvantages for both supplier and buyer. On the supplier's side, there can be doubt as to whether the check will be honored by the drawee bank, as well as delay in availability of funds, and there is again the potential for inconvenience in terms of depositing the check in the supplier's bank. From the buyer's point of view, using checks to settle COD transactions brings on requirements such as reconciling the checks with bank statements, and monitoring, safeguarding and tracking use of the buyer's check stock/checkbook.

### BRIEF DESCRIPTION OF THE DRAWINGS

Features and advantages of some embodiments of the present disclosure, and the manner in which the same are accomplished, will become more readily apparent upon consideration of the following detailed description of the invention taken in conjunction with the accompanying drawings, which illustrate preferred and example embodiments and which are not necessarily drawn to scale, wherein:

FIG. 1 is a block diagram of a payment system such as an EFT (electronic funds transfer) system.

FIG. 2 is block diagram that illustrates an embodiment of a payment system according to aspects of the present disclosure.

FIG. 3 is a block diagram that illustrates alternative aspects of the payment system of FIG. 2.

FIG. 4 is a simplified block diagram of a typical mobile device that may be employed by a supplier/payment recipient in the system of FIGS. 2 and/or 3.

FIG. 5 is a simplified block diagram of a typical mobile device that may be employed by a buyer in the system of FIGS. 2 and/or 3.

FIG. 6 is a block diagram of a computer system that may play a role in the system of FIGS. 2 and/or 3.

FIG. 7 if a block diagram of another computer system that may play a role in the system of FIG. 2.

FIGS. 8 and 9 are flow charts that illustrate processes that may be performed in accordance with aspects of the present disclosure.

### DESCRIPTION

In general, and for the purpose of introducing concepts of embodiments of the present disclosure, a supplier/payment recipient may call up or input invoice details on a mobile device with respect to goods that the supplier is delivering to a buyer. The payment recipient may transmit the invoice details in a payment request to a payment services provider along with an alias identifier for the buyer. The payment services provider may retrieve banking information for the payment recipient and the buyer, and then may transmit the payment request, including banking information, to the buyer's bank. The buyer's bank may transmit the invoice details and supplier/payment recipient identification to the buyer's mobile device (different from the payment recipient's mobile device) for review and confirmation by the buyer. The buyer may confirm (i.e., initiate a payment) to the buyer's bank, which may then execute an EFT (electronic funds transfer) transaction for the amount of the COD transaction, with debiting of the amount from the buyer's account at the buyer's bank and crediting of the payment recipient's account at the payment recipient's bank. The buyer's bank may confirm the EFT transaction to the payment services provider and to the buyer. The payment services provider may confirm the EFT transaction to the supplier/payment recipient. The payment recipient then knows that payment has been made for the goods that are being delivered to the buyer, so that the delivery transaction is complete.

This payment transaction arrangement may be highly convenient and efficient, while eliminating financial risk and inconvenience that may be experienced from payment by cash or check upon delivery of goods.

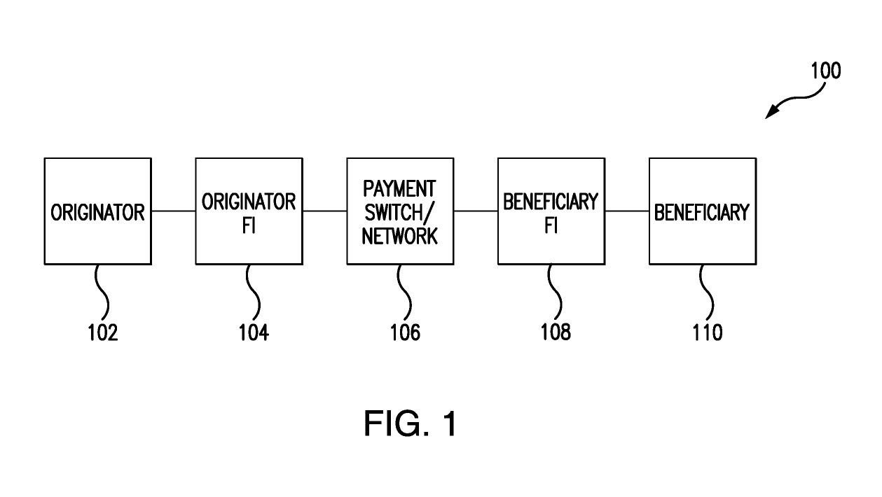

FIG. 1 is a block diagram that illustrates a payment network system 100, of which one example is the ACH (automated clearing house) system operated in the United States.

The system 100 includes an originator device 102, which may be a computer operated by an originator of a transaction. Common kinds of transactions are credit transactions and debit transactions. The originator is the party that initiates the transaction. The originator may be, for example, an individual or a corporation or other organization.

The system 100 further includes an originator FI (financial institution) computer 104. The originator FI computer 104 receives payment instructions from the originator and forwards data entries that reflect the instructions to a payment system switch/network 106, which is also part of the system 100. The originator FI computer 104 may be operated by an originator FI of which the originator is a customer. The switch/network 106 may be operated by a governmental or private entity that serves as a clearing facility for the system 100.

Also included in the system 100 is a beneficiary FI computer 108. The beneficiary FI computer 208 receives entries from the payment system switch/network 106 and posts entries to accounts of depositors.

Still further, the system 100 includes a beneficiary 110 that is one of the depositors of the beneficiary FI. In the case of a credit transaction, the account at the beneficiary FI of the beneficiary may be credited with the amount instructed to be paid by the originator device 102. The beneficiary may be, for example, an individual or a corporation or other organization. Both FIs may typically be banks, although other types of FIs or other types of organizations may play roles like the FIs referred to in connection with FIG. 1.

The communications among the parties in the system 100 may typically be conducted using XML (eXtensible Markup Language) and may comply with a standard according to ISO 20022.

The components of the system 100 as depicted in FIG. 1 are only those that are needed for processing a single transaction. A typical payment network system may process many transactions (including simultaneous transactions) and may include a considerable number of FIs and their computers, one or more clearing operators, and numerous originators and beneficiaries. A system of the kind illustrated in FIG. 1 is sometimes referred to as an EFT (electronic funds transfer) system.

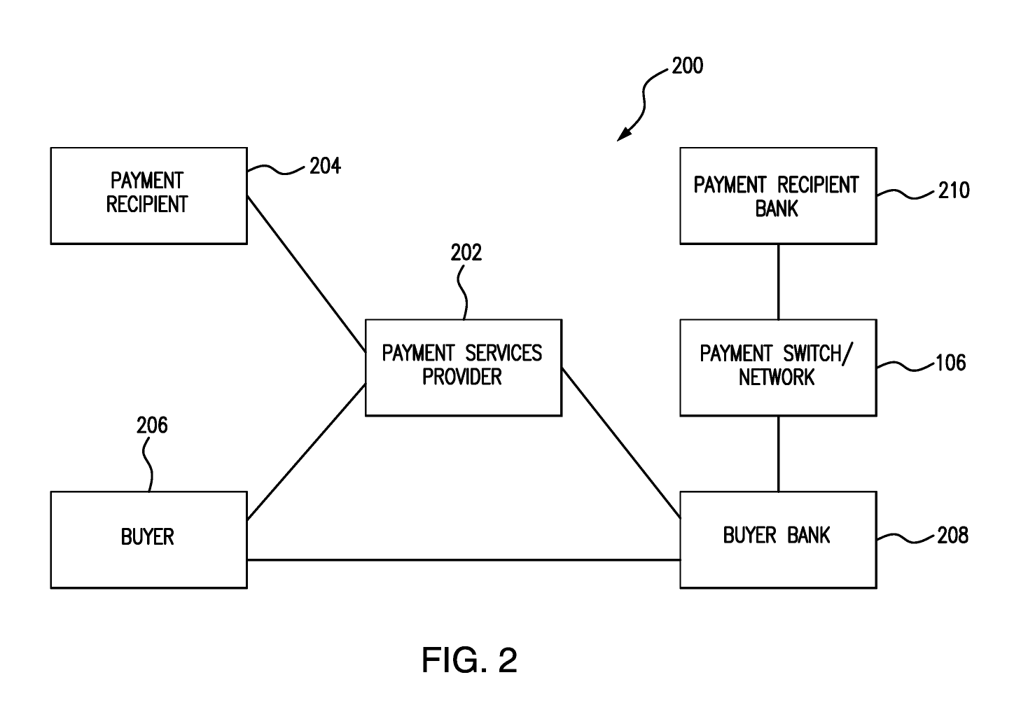

FIG. 2 is a block diagram of a payment system 200 provided in accordance with aspects of the present disclosure.

The payment system 200 may include a payment services provider 202. The payment services provider 202 may perform a central role in the payment system 200. Details of the payment services provider 202 and the functions it performs will be described below.

The payment system 200 may also include a payment recipient 204 and a buyer 206. The payment recipient 204 may be a supplier of goods to the buyer 206. The payment recipient 204 and the buyer 206 may both be located at the buyer's premises (not separately indicated) at the time a payment transaction is performed in accordance with teachings of this disclosure. Each of the payment recipient 204 and the buyer 206 may be in communication with the payment services provider 202 to allow the payment services provider to facilitate a payment in a manner described herein in connection with a delivery of goods by the payment recipient 204 to the buyer 206.

The payment system 200 may further include the buyer's bank 208—i.e., a bank or other financial institution at which the buyer has a deposit account. The payment services provider 202 may be in communication with the buyer's bank 208, which in turn may be in communication with the buyer 206.

The payment system 200, still further, may include a payment switch/network 106—i.e., akin to or indistinguishable from the payment switch/network 106 depicted in and described in connection with FIG. 1. In addition, the payment system 200 may include the payment recipient's bank 210. The payment recipient's bank 210 may be a bank or other financial institution at which the payment recipient 204 has a deposit account. The payment recipient's bank 210 may be similar to or indistinguishable from the beneficiary FI 108 shown in FIG. 1. The buyer's bank 208 may be in communication with the payment network/switch 106, which in turn may be in communication with the payment recipient's bank 210. The buyer's bank 208 may also be in communication with the buyer 206.

Each block that represents a party/entity in FIG. 2 should also be understood to represent a computing device or other intelligent device operated by or on behalf of the respective party/entity. Thus, block 204 should be deemed to represent a tablet computer, mobile handheld terminal or other similar device operated by the payment recipient or employee thereof. Block 206 should be deemed to represent a smartphone or other mobile device operated by the buyer or employee thereof. Each of blocks 202, 208, 106 and 210 should be deemed to represent a respective server computer, mainframe computer or dedicated or contracted-for cloud computing resources.

The components of the system 200 as depicted in FIG. 2 are only those that are needed for processing a single transaction. A practical embodiment of the payment system 200 may process many transactions (including simultaneous transactions) and may include more than one payment services provider, numerous payment recipients and buyers operating mobile devices, potentially a considerable number of buyer banks and payment recipient banks, and perhaps more than one payment switch/network.

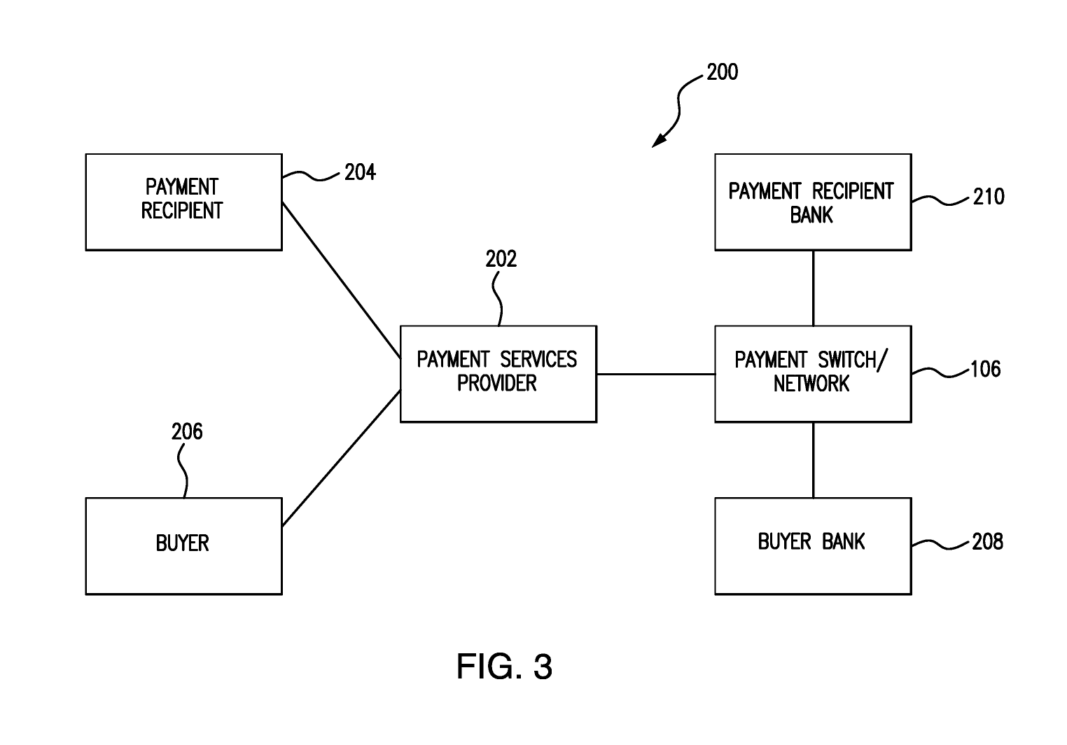

FIG. 3 is a block diagram of an alternative configuration of the payment system 200 of FIG. 2. All the components/entities as described above in connection with FIG. 2 are also present in FIG. 3. In the configuration of FIG. 3, the payment services provider 202 may be in communication with the payment switch/network 106 rather than with the buyer bank 208. As will be understood from subsequent discussion, the payment system 200 may implement the topology illustrated in FIG. 2 in connection with some transactions, and may implement the topology illustrated in FIG. 3 in connection with other transactions. The particular topology in effect for a given transaction may depend on pre-existing relationships between the parties. Alternatively, the disparate topologies shown in FIGS. 2 and 3 may be considered to represent different embodiments of the payment system 200.

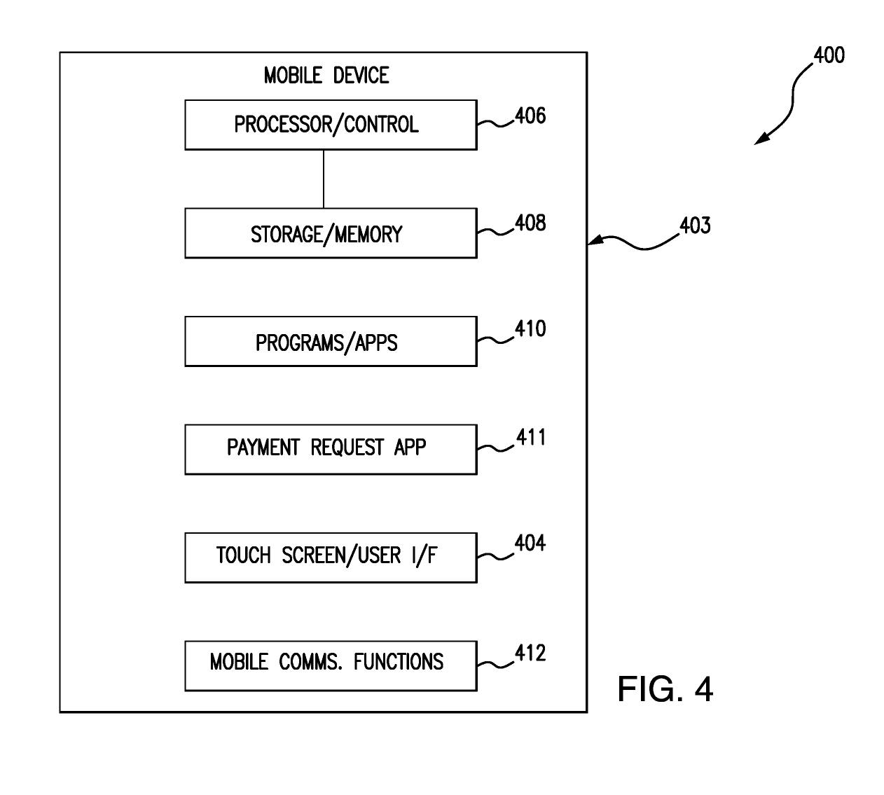

FIG. 4 is a simplified block diagram that illustrates a typical mobile device 400 that may be operated by or on behalf of the payment recipient/supplier 204 (FIG. 2). The ensuring discussion assumes that the mobile device 400 is embodied as a suitably programmed tablet computer, but that assumption is not intended to be limiting.

Referring now to FIG. 4, the mobile device 400 may include a housing 403. In many embodiments, the front of the housing 403 features a rather large touchscreen, which is a key element of the user interface 404 of the mobile device 400.

The mobile device 400 further includes a mobile processor/control circuit 406, which is contained within the housing 403. Also included in the mobile device 400 is a storage/memory device or devices (reference numeral 408). The storage/memory devices 408 are in communication with the processor/control circuit 406 and may contain program instructions to control the processor/control circuit 406 to manage and perform various functions of the mobile device 400. If embodied as a tablet computer, the mobile device 400 may function as what is in effect an easily carried and transportable personal computer, via programming with a number of application programs, or “apps,” as well as a mobile operating system (OS). (The apps are represented at block 410 in FIG. 4, and may, along with other programs, in practice be stored in block 408, to program the processor/control circuit 406.)

Also shown in FIG. 4 is a payment request app 411. The payment request app 411 is shown apart from the other apps represented at block 410, in view of the particular relevance of the payment request app 411 to the subject of this disclosure. The payment request app 411 may program the mobile device 400 to perform functions in connection with the payment system 200, as described below

As is generally the case for mobile devices, the mobile device 400 may include mobile communications functions as represented by block 412. The mobile communications functions may include voice and data communications via a mobile communication network (not shown) with which the mobile device 400 is registered.

From the foregoing discussion, it will be appreciated that the blocks depicted in FIG. 4 as components of the mobile device 400 may in effect overlap with each other, and/or there may be functional connections among the blocks which are not explicitly shown in the drawing. It may also be assumed that, like a typical tablet computer, the mobile device 400 may include a rechargeable battery (not shown) that is contained within the housing 403 and that provides electrical power to the active components of the mobile device 400.

Although the mobile device 400 has been described herein primarily as a tablet computer, in other embodiments, other types of mobile devices with similar capabilities may be used by the payment recipient in place of a tablet. For example, the mobile device 400 may be a specially designed and configured handheld device optimized to guide and facilitate the work of a delivery person who serves a delivery route. Alternatively, the mobile device 400 may be embodied as a smartphone.

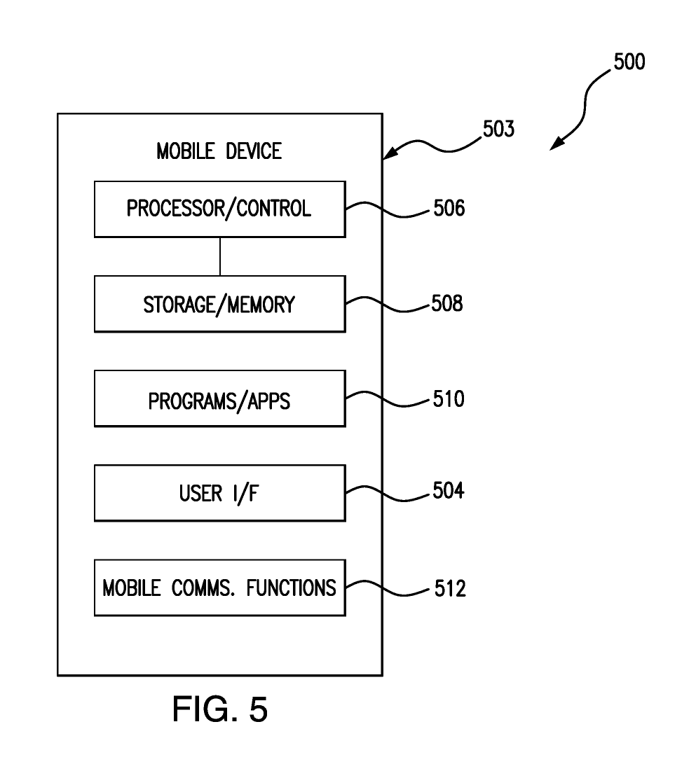

FIG. 5 is a simplified block diagram illustration of a typical mobile device 500 that may be used by the buyer in connection with the payment system 200 of FIGS. 2/3.

To some extent, it will be posited in the following discussion, without limitation, that the mobile device 500 is a smartphone.

The mobile device 500 may include a housing 503. In many embodiments, the front of the housing 503 is predominantly constituted by a touchscreen (not separately shown), which is a key element of the user interface 504 of the mobile device 500.

The mobile device 500 further includes a mobile processor/control circuit 506, which is contained within the housing 503. Also included in the mobile device 500 is a storage/memory device or devices (reference numeral 508). The storage/memory devices 508 are in communication with the processor/control circuit 506 and may contain program instructions to control the processor/control circuit 506 to manage and perform various functions of the mobile device 500. As is well-known, a smartphone may function as what is in effect a pocket-sized personal computer, via programming with a number of application programs, or “apps,” as well as a mobile operating system (OS). (The apps are represented at block 510 in FIG. 5, and may, along with other programs, in practice be stored in block 508, to program the processor/control circuit 506.) In some embodiments, a specialized app (not separately shown) may run in the mobile device 500 to support functioning of the mobile device 500 in connection with the payment system 200. However, in other embodiments, the mobile device may perform required functionality as described herein via a mobile browser (not separately shown) that interacts with one or more webpages hosted by other parties in the payment system 200.

As is typical for smartphones, the mobile device 500 may include mobile communications functions as represented by block 512. The mobile communications functions may include voice and data communications via a mobile communication network (not shown) with which the mobile device 500 is registered.

From the foregoing discussion, it will be appreciated that the blocks depicted in FIG. 5 as components of the mobile device 500 may in effect overlap with each other, and/or there may be functional connections among the blocks which are not explicitly shown in the drawing. It may also be assumed that, like a typical smartphone, the mobile device 500 may include a rechargeable battery (not shown) that is contained within the housing 503 and that provides electrical power to the active components of the mobile device 500.

Although the mobile device 500 has been described herein primarily as a smartphone, in other embodiments, other types of mobile devices (e.g., a tablet computer) may be used in place of a smartphone.

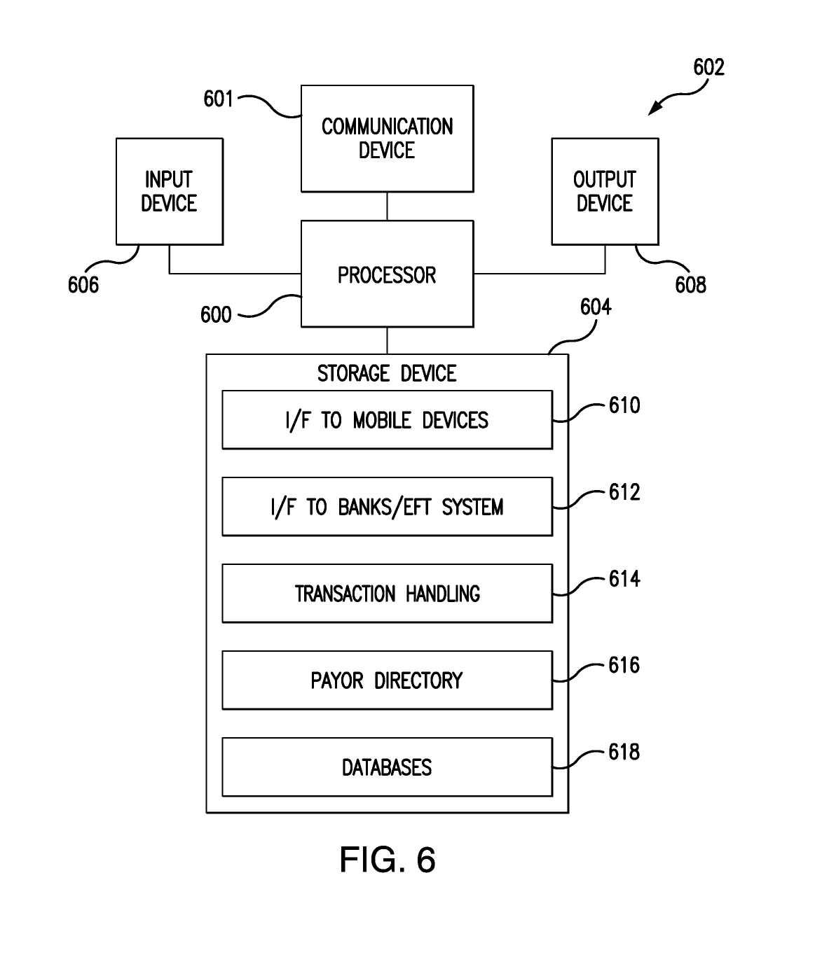

FIG. 6 is a block diagram of an example computer system 602 that may perform functions in the payment system of FIGS. 2/3. The computer system 602 may be operated by the payment services provider 202, and may accordingly be referred to hereinafter as a “payment services provider computer.”

Referring now to FIG. 6, the payment services provider computer 602 may, in its hardware aspects, resemble a typical server computer and/or mainframe computer, but may be controlled by software to cause it to function as described herein.

The payment services provider computer 602 may include a computer processor 600 operatively coupled to a communication device 601, a storage device 604, an input device 606 and an output device 608. The communications device 601, the storage device 604, the input device 606 and the output device 608 may all be in communication with the processor 600.

The computer processor 600 may be constituted by one or more processors. Processor 600 operates to execute processor-executable steps, contained in program instructions described below, so as to control the payment services provider computer 602 to provide desired functionality.

Communication device 601 may be used to facilitate communication with, for example, other devices (such as other components of the payment system 200). Communication device 601 may comprise numerous communication ports (not separately shown), to allow the payment services provider computer 602 to communicate simultaneously with a number of other computers and other devices, including communications as required to simultaneously handle numerous requests for payment transactions.

Input device 606 may comprise one or more of any type of peripheral device typically used to input data into a computer. For example, the input device 606 may include a keyboard and a mouse. Output device 608 may comprise, for example, a display and/or a printer.

Storage device 604 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 604 stores one or more programs for controlling processor 600. The programs comprise program instructions (which may be referred to as computer readable program code means) that contain processor-executable process steps of the payment services provider computer 602, executed by the processor 600, to cause the payment services provider computer 602 to function as described herein.

The programs may include one or more conventional operating systems (not shown) that control the processor 600 so as to manage and coordinate activities and sharing of resources in the payment services provider computer 602, and to serve as a host for application programs (described below) that run on the payment services provider computer 602.

The programs stored in the storage device 604 may include, for example, a software interface 610 that supports communications between the payment services provider computer 602 and mobile devices operated by payment recipients and/or buyers.

The storage device 604 may further store a software interface 612 that supports communications between the payment services provider computer 602 and a number of buyer's banks such as the bank 208 shown in FIG. 2. In addition or alternatively, the software interface 612 may support communications between the payment services provider computer 602 and the payment switch/network 106.

Still further, the storage device 604 may store a transaction handling application program 614. The transaction handling application program 614 may operate to handle payment transactions requested by payment recipients and confirmed by buyers, as described herein.

The storage device 604 may also store, and the payment services provider computer 602 may also execute, other programs, which are not shown. For example, such programs may include communications software and a reporting application. The latter program may respond to requests from system administrators for reports on the activities performed by the payment services provider computer 602. The other programs may also include, e.g., device drivers, database management software, etc.

In addition, the storage device 604 may store a directory 616 of individuals/organizations that may render or receive payments via the payment system 200. The directory may map users' alias identifiers to the banking details, such as the users' banks and bank account numbers. It is to be understood that the buyer 206 shown in FIG. 2 may be one such user.

The storage device 604 may also store one or more databases 618 needed for operation of the payment services provider computer 602.

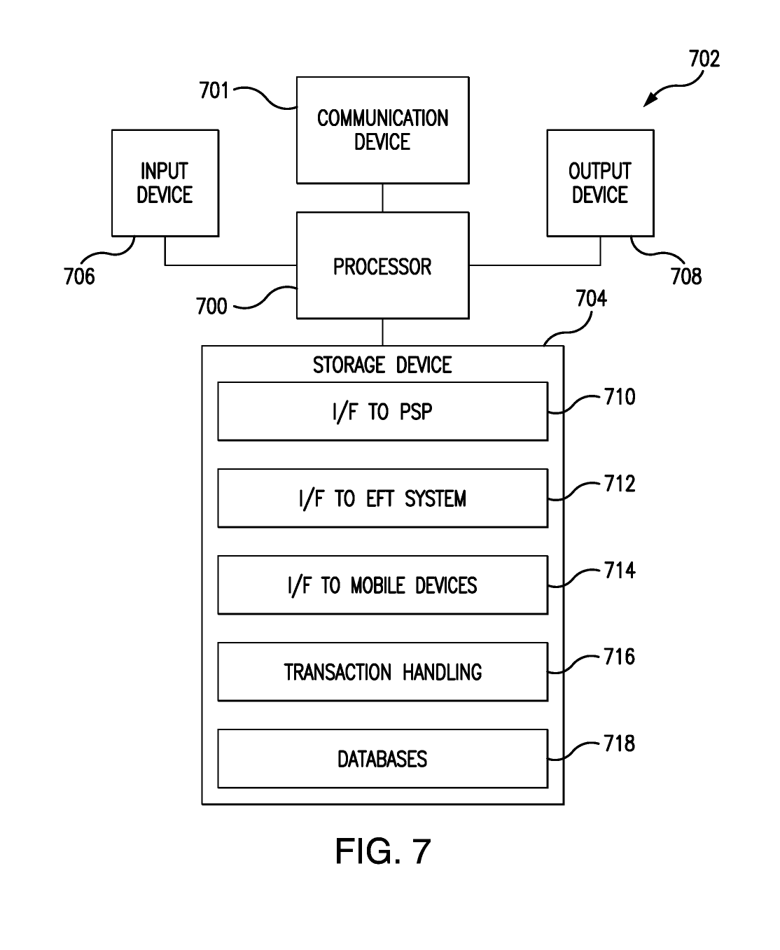

FIG. 7 is a block diagram of an example computer system 702 that may perform functions in the payment system of FIGS. 2/3. The computer system 702 may be operated by the buyer's bank 208, and may accordingly be referred to hereinafter as a “bank computer”. The bank computer 702 may be constituted by computer hardware having the same types of components and hardware architecture as described herein with reference to FIG. 6. Accordingly, the bank computer 702 may include a computer processor 700 operatively coupled to a communication device 701, a storage device 704, an input device 706 and an output device 708. The communications device 701, the storage device 704, the input device 706 and the output device 708 may all be in communication with the processor 700.

Storage device 704 stores one or more programs for controlling processor 700. The programs comprise program instructions (which may be referred to as computer readable program code means) that contain processor-executable process steps of the bank computer 702, executed by the processor 700, to cause the bank computer 702 to function as described herein.

The programs may include one or more conventional operating systems (not shown) that control the processor 700 so as to manage and coordinate activities and sharing of resources in the bank computer 702, and to serve as a host for application programs (described below) that run on the bank computer 702.

The programs stored in the storage device 704 may include, for example, a software interface 710 that supports communications between the bank computer 702 and the payment services provider computer 602.

The storage device 704 may further store a software interface 712 that supports communications between the bank computer 702 and the payment switch/network 106.

Still further, the storage device 704 may store a software interface 714 that supports communications between the bank computer 702 and mobile devices operated by buyers/bank customers.

In addition, the storage device 704 may store a transaction handling application program 716. The transaction handling application program 716 may operate to handle payment transactions confirmed for execution by bank customers/buyers, as described herein.

The storage device 704 may also store, and the bank computer 702 may also execute, other programs, which are not shown. For example, such programs may include communications software and a reporting application. The latter program may respond to requests from system administrators for reports on the activities performed by the bank computer 702. The other programs may also include, e.g., device drivers, database management software, etc.

The storage device 704 may also store one or more databases 718 needed for operation of the bank computer 702.

In operation, the system 200 may require payment recipients and buyers to register before using the system 200 to engage in payment transactions. In some embodiments, there may be two options for registration of payment recipients and buyers. According to the first option, payment recipients and/or buyers may interact with the payment services provider 202 (e.g., via one or more websites hosted by the payment services provider 202). In such interactions, the payment recipient or buyer, as the case may be, may create a user profile in the payment services provider computer 602. The profile may include a proxy identifier/alias (e.g., phone number or e-mail address) for the user along with bank account details (such as routing number, account number, etc.). In the case of the payment recipient, a name (e.g., a business name) and address may be supplied for the profile in addition to or instead of the proxy identifier.

According to another option, registration with the payment services provider may occur via the users' banks. In such a case, the user may opt in to the user's bank's directory, by authorizing the bank to create a user profile to be shared with the payment services provider. The profile may have the same type of information referred to in the previous paragraph and may include only information that is already available in the bank's data processing systems. This option may be preferable in that it may relieve the users from performing data entry, and may allow the payment services provider to market the payment services described herein on a large scale via the users' banks. Also, with profiles generated by the users' banks, the payment services provider may receive the user profiles in batches from the banks, thereby conserving computing resources for the payment services provider.

As will be seen from further discussion, in some embodiments options may be offered for buyers to register with the payment services provider at the time a delivery transaction is occurring.

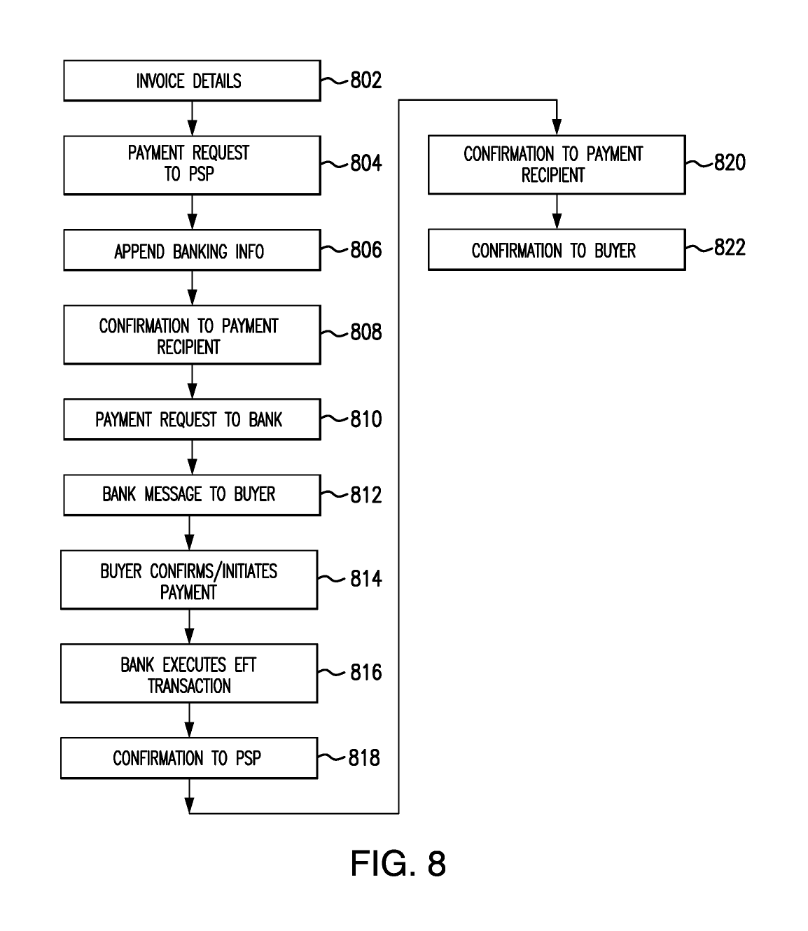

FIG. 8 is a flow chart that illustrates a process that may be performed according to aspects of the present disclosure.

At 802 in FIG. 8, the payment recipient's employee (i.e., an individual who is performing a delivery to the buyer) may bring up the details of the delivery transaction on the mobile device 400 (FIG. 4). The delivery transaction details may take the form of an invoice, including a total transaction price and a list of the items that are being delivered. The invoice may also include the payment recipient's name (e.g., company name) as well as the proxy identifier for the buyer. In some embodiments, this information may have been downloaded to the mobile device 400 from the payment recipient's ERP (enterprise resource planning) system (not separately shown). In other embodiments, this information (or at least some of it) may be entered manually into the mobile device 400 by the payment recipient's employee.

Block 804 may follow block 802 in the process of FIG. 8. At block 804, the mobile device 400 may transmit, and the payment services provider 202 may receive, a request for payment to be made to the payment recipient. The request for payment may include the invoice details and identifier/name of the payment recipient and the buyer.

At block 806, the payment services provider 202 may append additional information to the request for payment. The additional information may include the banking details (bank name/routing number and account number) for the payment recipient and the buyer. This appending process may include retrieving such additional information from the one or more directories (e.g., the payor directory 616, FIG. 6) stored by the payment services provider 202.

Possibly in parallel with block 806, block 808 may be performed. At block 808, the payment services provider 202 may transmit a confirmation to the mobile device 400 that the request for payment was received and is being processed.

At block 810, the payment services provider 202 may transmit the request for payment (including payment recipient's banking details and buyer's account number) to the buyer's bank 208. Block 810 may also be understood to represent the buyer's bank 208 receiving the request for payment, as transmitted by the payment services provider 202.

At block 812, the buyer's bank 208 may transmit a message to the buyer (i.e., to the buyer's mobile device 500). The message may include the invoice details, including the list of items being delivered for sale to the buyer, and the name of the payment recipient. It may be desirable that the message sent at 812 to the buyer not include the payment recipient's banking details; i.e., it may be desirable that the latter information be kept private from the buyer. The message may prompt the buyer to review the invoice and to confirm that the buyer's wish is that the requested payment be made.

At block 814, the buyer/buyer's employee may confirm that the requested payment go forward. This may involve the buyer/buyer's employee interacting with the mobile device 500. For example, the buyer/buyer's employee may actuate a virtual button such as “confirm payment” displayed by the mobile device 500. The process at block 814 may also include the mobile device 500 requiring user authentication of the buyer/buyer's employee before the confirmation of payment is allowed to become effective. The user authentication may include entry of a PIN (personal identification number) or password or a biometric user authentication process (e.g., fingerprint scan and verification). Block 814 may also be considered to include transmission to the buyer's bank from the mobile device 500 of the buyer's confirmation of the request for payment, as well as receipt of the confirmation by the buyer's bank.

Block 816 may occur in response to the bank's receipt of the buyer's confirmation. At block 816, the buyer's bank may initiate an EFT/ACH transaction to transfer the total amount of the invoice (i.e., the requested payment amount) from the buyer's bank account to the payment recipient's bank account. It may also be assumed in connection with block 816 that the EFT/ACH transaction is completed successfully, including involvement of the payment switch/network 106 in response to funds transfer messaging by the buyer's bank 208, and receipt of the funds transfer by the payment recipient's bank 210 on behalf of the payment recipient.

At block 818, the buyer's bank 208 may send a confirmation message to the payment services provider 202 to confirm that the requested payment funds transfer has been completed.

At block 820, the payment services provider 202 may send a confirmation to the mobile device 400 in order to confirm to the payment recipient's employee that payment for the delivery has occurred. The delivery transaction may then be deemed complete, and the payment recipient's employee may leave the buyer's premises, with the delivered (and now paid-for) goods remaining with the buyer.

At block 822, the buyer's bank 208 may send a confirmation message to the mobile device 500 in order to confirm to the buyer/buyer's employee that the payment transaction funds transfer has occurred.

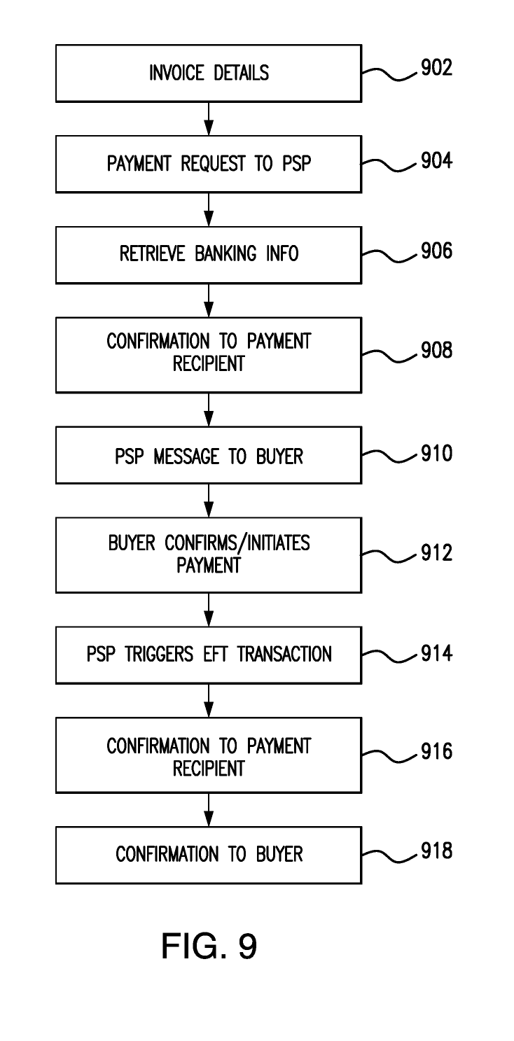

In the process of FIG. 8, it has been assumed that there has been a functional and data communications integration between the payment service provider's data processing system and the buyer's bank's data processing system, whereby the interaction between the payment service provider and the buyer's bank is enabled, particularly as referred to in connection with steps 810 through 818 of FIG. 8. In other embodiments, or at least with respect to other transactions, such integration may not have occurred. Consequently, an alternative process flow may take place, as now will be described with reference to FIG. 9.

FIG. 9 is a flow chart that illustrates a process that may be performed in accordance with aspects of the present disclosure.

At 902 in FIG. 9 (similarly to block 802 in FIG. 8), the payment recipient's employee (i.e., an individual who is performing a delivery to the buyer) may bring up the details of the delivery transaction on the mobile device 400 (FIG. 4). The delivery transaction details may take the form of an invoice, including a total transaction price and a list of the items that are being delivered. The invoice may also include the payment recipient's name (e.g., company name) as well as the proxy identifier for the buyer. In some embodiments, this information may have been downloaded to the mobile device 400 from the payment recipient's ERP system (not separately shown). In other embodiments, this information (or at least some of it) may be entered manually into the mobile device 400 by the payment recipient's employee.

Block 904 (similar to block 804 in FIG. 8) may follow block 902 in the process of FIG. 9. At block 904, the mobile device 400 may transmit, and the payment services provider 202 may receive, a request for payment to be made to the payment recipient. The request for payment may include the invoice details and identifier/name of the payment recipient and the buyer.

At block 906, the payment services provider 202 may retrieve banking information that is pertinent to the request for payment. The banking information may include the banking details (bank name/routing number and account number) for the payment recipient and the buyer. The banking information may be retrieved by the payment services provider 202 from the one or more directories (e.g., the payor directory 616, FIG. 6) stored by the payment services provider 202.

Possibly in parallel with block 906, block 908 may be performed. At block 908 (similar to block 808), the payment services provider 202 may transmit a confirmation to the mobile device 400 that the request for payment was received and is being processed.

At block 910, the payment services provider 202 may transmit a message to the buyer (i.e., to the buyer's mobile device 500). The message may include the invoice details, including the list of items being delivered for sale to the buyer, and the name of the payment recipient. It may be desirable that the message sent at 910 to the buyer not include the payment recipient's banking details; i.e., it may be desirable that the latter information be kept private from the buyer. The message may prompt the buyer to review the invoice and to confirm that the buyer's wish is that the requested payment be made.

At block 912 (similar to block 814), the buyer/buyer's employee may confirm that the requested payment go forward. This may involve the buyer/buyer's employee interacting with the mobile device 500. For example, the buyer/buyer's employee may actuate a virtual button such as “confirm payment” displayed by the mobile device 500. The process at block 912 may also include the mobile device requiring user authentication of the buyer/buyer's employee before the confirmation of payment is allowed to become effective. The user authentication may include entry of a PIN or password or a biometric user authentication process (e.g., fingerprint scan and verification). The buyer's confirmation that the payment should proceed may also include the buyer's consent that the payment services provider may use the buyer's banking information to initiate the payment transaction. Block 912 may also be considered to include transmission to the payment services provider from the mobile device of the buyer's confirmation of the request for payment, as well as receipt of the confirmation by the payment services provider.

Block 914 may occur in response to the payment services provider's receipt of the buyer's confirmation. At block 914, the payment services provider may communicate with the payment switch/network 106 (e.g., as per the topology of FIG. 3) to initiate an EFT/ACH transaction to transfer the total amount of the invoice (i.e., the requested payment amount) from the buyer's bank account to the payment recipient's bank account. It may also be assumed in connection with block 914 that the EFT/ACH transaction is completed successfully, including involvement of the payment switch/network 106 to execute a transfer of funds from the buyer's bank 208 to the payment recipient's bank 210.

At block 916, the payment services provider 202 may send a confirmation to the mobile device 400 in order to confirm to the payment recipient's employee that payment for the delivery has occurred. The delivery transaction may then be deemed complete, and the payment recipient's employee may leave the buyer's premises, with the delivered (and now paid-for) goods remaining with the buyer.

At block 918, the payment services provider 202 may send a confirmation message to the buyer's mobile device 500 in order to confirm to the buyer/buyer's employee that the payment transaction funds transfer has occurred.

With payment transaction flows as described above in connection with FIGS. 8 and 9, a COD-type transaction may be facilitated via data communications and access to an EFT/ACH payment system, and without the inconvenience or risk involved with payment by cash or check.

The above-described scenarios have assumed that the seller/supplier's employee is delivering the goods to be sold to a buyer at the buyer's premises, e.g., in a commercial context. However, an individual consumer's COD transaction can also be readily accommodated with similar process flows. For example, in an alternative scenario, the supplier hires a delivery company (e.g., Fedex® or UPS®) to deliver an ordered item to the consumer/buyer. In such a scenario, the mobile device 400 may be carried and operated by the delivery company employee, who requests payment and receives confirmation of payment via the mobile device 400 and on behalf of the seller. It may be assumed that data communication takes place between ERP systems (not shown) operated by the seller and the delivery company, respectively.

In some scenarios, at the time of delivery, the buyer has not yet registered with the payment services provider 202. In such cases, the supplier's/delivery company's employee may communicate with the payment services provider to send a suitable link to the buyer's mobile device 500, to allow the buyer to register on the spot with the payment services provider. In the registration process, the buyer may interact with their mobile device 500 to indicate his/her banking details to the payment service provider to facilitate the current COD transaction and future similar transactions. In some embodiments, the registration process may include user authentication of the buyer via an authentication service provided by the buyer's bank. That is, the payment services provider website may hand the communication session with the mobile device 500 over to the buyer's bank for user authentication before completing the registration of the buyer and proceeding with the payment transaction.

Although transactions described herein explicitly refer to purchases of goods, this is not intended to be limiting; i.e., the payment arrangements described herein are also applicable to purchases of services.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omitting one or more steps.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a request for payment from a payment recipient, the request for payment including (a) invoice details and a transaction amount for a transaction between the payment recipient and a buyer; (b) identification of the payment recipient; and (c) an identifier that identifies the buyer;
appending, to the received request for payment, payment recipient account information and buyer account information, the payment recipient account information identifying the payment recipient's bank and bank account, the buyer account information identifying the buyer's bank and bank account;
transmitting the request for payment, including the recipient account information and at least a portion of the buyer account information, to the buyer's bank; and
receiving confirmation from the buyer's bank that the request for payment has been executed.

2. The method of claim 1, further comprising:
transmitting a funds transfer confirmation to the payment recipient.

3. The method of claim 1, further comprising:
prior to the appending step, receiving a request to register the buyer, the request received from the payment recipient.

4. The method of claim 3, further comprising:
responding to said request to register by transmitting an inquiry to the buyer, the inquiry for requesting said buyer account information.

5. The method of claim 4, further comprising:
receiving said buyer account information from the buyer.

6. The method of claim 5, further comprising:
transmitting a hyperlink to the buyer, the hyperlink for allowing the buyer to access a customer service online resource provided by the buyer's bank.

7. The method of claim 6, further comprising:
receiving confirmation from the buyer's bank that the buyer's bank has authenticated the buyer.

8. The method of claim 1, wherein the identifier that identifies the buyer includes at least one of: (a) the buyer's email address; and (b) the buyer's mobile telephone number.

9. The method of claim 1, wherein the invoice details includes a list of products purchased by the buyer from the payment recipient.

10. A method comprising:
receiving a request for payment from a payment services provider, the request including (a) invoice details and a transaction amount for a transaction between the payment recipient and a buyer; (b) identification of the payment recipient; (c) an identifier that identifies the buyer; (d) payment recipient account information; and (e) buyer account information; the payment recipient account information identifying the payment recipient's bank and bank account, the buyer account information identifying the buyer's bank account;
transmitting the invoice details and identification of the payment recipient to the buyer;
receiving a confirmation signal from the buyer;
in response to the confirmation signal, initiating a funds transfer from the buyer's account to the payment recipient's account; and
transmitting a funds transfer confirmation to the payment services provider.

11. The method of claim 10, further comprising:
transmitting a funds transfer confirmation to the buyer.

12. The method of claim 10, wherein the funds transfer is executed in an EFT (electronic funds transfer) system.

13. The method of claim 12, wherein the funds transfer is executed in an ACH (automated clearing house) system.

14. The method of claim 10, further comprising:
receiving a registration request from the buyer prior to receiving the request for payment.

15. The method of claim 14, further comprising:
authenticating the buyer after receiving the registration request and prior to receiving the request for payment.

16. The method of claim 15, further comprising:
prior to receiving the request for payment, indicating to the payment services provider that the buyer has been authenticated.

17. A method comprising:
receiving a request for payment from a payment recipient, the request for payment including (a) invoice details and a transaction amount for a transaction between the payment recipient and a buyer; (b) identification of the payment recipient; and (c) an identifier that identifies the buyer;
retrieving payment recipient account information and buyer account information from a directory; the payment recipient account information identifying the payment recipient's bank and bank account, the buyer account information identifying the buyer's bank and bank account;
transmitting the invoice details and identification of the payment recipient to the buyer;
receiving a confirmation signal from the buyer;
in response to the confirmation signal, initiating a funds transfer from the buyer's bank account to the payment recipient's bank account; and
transmitting a funds transfer confirmation to the payment recipient.

18. The method of claim 17, further comprising:
transmitting a funds transfer confirmation to the buyer.

19. The method of claim 17, wherein the funds transfer is executed in an EFT (electronic funds transfer) system.

20. The method of claim 19, wherein the funds transfer is executed in an ACH (automated clearing house) system.
